(19) United States
(12) Patent Application Publication
(10) Pub. No.: US 2025/0271586 A1
(43) Pub. Date: Aug. 28, 2025

(54) Irregular Nominal Shot Point Intervals for Cyclic Source Groups in Marine Seismic Surveys

(71) Applicant: PGS Geophysical AS, Oslo (NO)

(72) Inventors: Julien Oukili, Oslo (NO); Okwudili Orji, Oslo (NO)

(73) Assignee: PGS Geophysical AS, Oslo (NO)

(21) Appl. No.: 19/064,360

(22) Filed: Feb. 26, 2025

Related U.S. Application Data
(60) Provisional application No. 63/558,351, filed on Feb. 27, 2024.

(51) Int. Cl. G01V 1/38; G01V 1/04

(52) U.S. Cl. CPC G01V 1/3843; G01V 1/04

(57) ABSTRACT

A cyclic source group for marine seismic surveying includes a set of three or more impulsive marine seismic sources and at least one controller configured to activate the sources in sequential activation cycles. The activation cycles are such that exactly one nominal shot point occurs for each of the sources in the set during each activation cycle and all nominal shot points within a given activation cycle are distinct. Pairs of sequential nominal shot points within the activation cycle and across sequential activation cycles define respective nominal shot point intervals. At least two of the nominal shot point intervals are unequal, but nominal shot points for each individual source in the set occur at regular intervals.

### CROSS REFERENCE TO RELATED APPLICATIONS

This application claims benefit to the filing date of prior U.S. Patent Application No. 63/558,351, filed on 2024 Feb. 27 (the “Provisional Application”), the contents of which are hereby incorporated by reference as if entirely set forth herein. In the event of conflict between the meaning of a term used in this document and the same or a similar term used in the Provisional Application or in another document incorporated herein by reference, the meaning associated with this document shall control.

### BACKGROUND

Marine seismic surveys are performed in large bodies of water to gain information about geological features beneath the water bottom. Some surveys are performed to identify locations of hydrocarbon reservoirs or to determine changes in the properties of such reservoirs. Other surveys, sometimes referred to as site surveys or shallow target surveys, are performed to assess the suitability of a site for an installation of structures such as wind turbines, pipelines, or cables, or to inspect existing installations. Surveys that are performed to image hydrocarbon reservoirs are typically designed for targets disposed at substantial depths, on the order of 500 meters to several thousand meters below the water bottom. Site surveys seek to image shallower targets. In a typical site survey, subsurface features between about 0 and 500 meters below the water bottom (“shallow targets”) are of interest because features at those depths can influence locations and foundation designs for structures to be installed at the site.

In these and other types of marine seismic surveys, one or more impulsive sources may be used to generate acoustic energy that propagates from the source location toward reflectors disposed beneath the water bottom while reflected energy is recorded by a set of geophysical sensors. A nonlimiting example of an impulsive source suitable for such applications is an air gun array. An air gun array consists of one or more individual air guns coupled to a frame or harness that can be towed behind a vessel. Although an air gun array usually comprises more than one individual air gun, and although the individual air guns within an array sometimes differ in size or other characteristics, such an array is referred to as a single seismic “source” because the guns in the array are designed to activate simultaneously or nearly simultaneously responsive to a single source activation signal that emanates from a controller onboard the towing vessel. When activated, each air gun in the array releases a sudden burst of compressed air, which generates a pressure wave in the water. Typically, the guns in an array are designed in such a manner that their tandem activations produce a composite pressure wave that has desired frequency, amplitude, and/or directionality characteristics.

Unlike non-impulsive sources (e.g., marine vibrators), which generate a continuous pressure wave that varies in frequency over a sweep time lasting from seconds to minutes, each activation of an impulsive seismic source corresponds to a discrete pressure impulse whose duration is usually measured in milliseconds. For this reason, an activation of an impulsive source is referred to as a “shot.” Similarly, a “shot record” corresponds to a time span in the recorded sensor data that begins when a source is activated and that has sufficient duration to include reflections of interest that are produced by that source activation. A shot record may or may not actually be recorded as a discrete record when a survey is performed, but may instead correspond to a time slice taken from a set of continuously recorded sensor data as needed. A clean shot record duration refers loosely to a period of time beginning with the occurrence of a source activation (a shot) and ending when interfering energy from a subsequent shot appears in the shot record. As used herein, the phrase “clean shot record duration” may be defined simply as the length of time between two consecutive shots in a survey segment.

In part because of the costs associated with marine operations, every marine survey is planned in advance, and a so-called pre-plot is produced for each survey to specify how the survey is to be performed. For surveys that use impulsive sources, such a pre-plot includes an indication of the sail lines to be traversed by the towing vessel and also includes a set of regularly spaced nominal shot points along each sail line, at which points an impulsive source is to be activated as the vessel traverses the line. Traditionally, the nominal shot points for a given survey were specified to be far enough apart so that, assuming the tow vessel traveled at a specified speed, the acoustic energy attributable to a previous shot had time to dissipate to tolerable levels before reflections from a subsequent shot were expected to be recorded by the sensors. Thus, the nominal shot points were spaced far enough apart to ensure an adequate clean shot record duration for each shot in the recorded data. By way of example, conventional dual-source surveys were performed in this manner. In such surveys, two impulsive sources were alternately activated at regular intervals in a “flip flop” manner with sufficient time elapsing between source activations to ensure a lengthy clean shot record duration for each shot.

More recently, impulsive source surveys have employed so-called simultaneous shooting techniques in order to improve spatial sampling and to improve survey efficiency. In a simultaneous shooting survey, at least two impulsive sources disposed at different locations are activated simultaneously or nearly simultaneously, and the reflections attributable to each source are recorded together by the sensors in a blended fashion. Later, in data processing, a number of known “deblending” techniques can be used to separate signals in the recorded energy so that reflections attributable to a first source activation, for example, can be distinguished from reflections that are attributable to activations of other sources. In the conventional dual-source surveys described above, such deblending was not necessary because the reflected energy from each individual shot was already separate from that of other shots when the reflections were recorded in the field.

It is known to program a gun controller to add a “dither” to each nominal shot point during the performance of a simultaneous shooting survey to aid in the source energy deblending process. For example, control equipment onboard a survey vessel may consult a prepared table of dither values to determine which dither values to apply to which nominal shot points as the survey proceeds. Such a dither value may be positive or negative and may be specified in temporal terms (e.g., a random time value in the range of +/−500 milliseconds) or in spatial terms (e.g., a random distance value in the range of +/−2 meters).

Another modern surveying technique is known as 4D or time lapse surveying. In 4D surveying, two or more surveys are performed over the same geographic area at different times to detect changes that have occurred in subsurface geology over the time that elapsed between the surveys. Because geological changes occur over long periods of time—over periods measured in months or years—a later 4D survey (the “monitor” survey) is performed months or years after an earlier survey (the “baseline” survey) is performed. In this context, a baseline survey is always a previous survey relative to any monitor survey, and any given monitor survey may become a baseline survey relative to a subsequently performed survey. Thus, the terms “baseline,” “previous,” “prior,” and the like, may be used interchangeably herein, and the terms “monitor,” “subsequent,” “later,” and the like, may be used interchangeably herein. Two or more surveys that occur simultaneously or soon after one another (e.g., during the same mobilization of equipment and vessels over a given area) do not constitute 4D surveys because no subsurface geological changes can be detected over such a short period of time.

Great care is taken during the performance of a 4D monitor survey to reproduce as closely as possible the conditions of the baseline survey, so that differences in the survey results are more likely attributable to subsurface changes than to differences in the equipment configurations used in the two surveys.

### BRIEF DESCRIPTION OF THE DRAWINGS

FIGS. 1 and 2 are top and side views, respectively, illustrating an example towed streamer marine seismic survey in accordance with embodiments.

FIG. 3 is a side view illustrating an example ocean bottom cable marine seismic survey in accordance with embodiments.

FIG. 4 is a side view illustrating an example ocean bottom node marine seismic survey in accordance with embodiments.

FIGS. 5-7 are block diagrams schematically illustrating example groupings of seismic sensors suitable for use in any of the surveys of FIGS. 1-4.

FIG. 8 is a diagram illustrating several types of offsets in marine seismic surveys.

FIG. 9 is a block diagram illustrating an example computing device that may be used to implement methods and apparatus in accordance with embodiments.

FIG. 10 is a schematic diagram illustrating a first example activation pattern for a cyclic source group in accordance with embodiments.

FIG. 11 is a schematic diagram illustrating a second example activation pattern for a cyclic source group in accordance with embodiments.

FIG. 12 is a schematic diagram illustrating a first example of how the activation pattern of FIG. 11 may be used in a 4D monitor survey to repeat shot lines from a baseline survey while adding a source relative to the number of sources used in the baseline survey.

FIG. 13 is a schematic diagram illustrating a second example of how the activation pattern of FIG. 11 may be used in a 4D monitor survey to repeat shot lines from a baseline survey while adding a source relative to the number of sources used in the baseline survey.

FIG. 14 is a schematic diagram illustrating a third example activation pattern for a cyclic source group in accordance with embodiments.

FIG. 15 is a schematic diagram illustrating a first example of how the activation pattern of FIG. 14 may be used in a 4D monitor survey to repeat shot lines from a baseline survey while adding two sources relative to the number of sources used in the baseline survey.

FIG. 16 is a schematic diagram illustrating a second example of how the activation pattern of FIG. 14 may be used in a 4D monitor survey to repeat shot lines from a baseline survey while adding two sources relative to the number of sources used in the baseline survey.

FIG. 17 is a flow diagram illustrating methods for manufacturing geophysical data products in accordance with embodiments.

FIG. 18 is a top view illustrating example locations at which cyclic source groups in accordance with embodiments may be deployed in a towed streamer survey.

### DETAILED DESCRIPTION

This disclosure describes multiple embodiments by way of example and illustration. It is intended that characteristics and features of all described embodiments may be combined in any manner consistent with the teachings, suggestions and objectives contained herein. For example, elements of a first described embodiment may be substituted for or combined with elements of any one or more other described embodiment to yield additional embodiments. Thus, phrases such as “in an embodiment,” “in one embodiment,” and the like, when used to describe embodiments in a particular context, are not intended to limit the described characteristics or features only to the embodiments appearing in that context.

The phrases “based on” or “based at least in part on” refer to one or more inputs that can be used directly or indirectly in making some determination or in performing some computation. Use of those phrases herein is not intended to foreclose using additional or other inputs in making the described determination or in performing the described computation. Rather, determinations or computations so described may be based either solely on the referenced inputs or on those inputs as well as others.

The phrase “configured to” as used herein means that the referenced item, when operated, can perform the described function. In this sense an item can be “configured to” perform a function even when the item is not operating and is therefore not currently performing the function. Use of the phrase “configured to” herein does not necessarily mean that the described item has been modified in some way relative to a previous state.

“Coupled” as used herein refers to a connection between items. Such a connection can be direct or can be indirect through connections with other intermediate items.

Terms used herein such as “including,” “comprising,” and their variants, mean “including but not limited to.”

Articles of speech such as “a,” “an,” and “the” as used herein are intended to serve as singular as well as plural references except where the context clearly indicates otherwise. For example, articles of speech such as “a,” “an,” and “the,” when used in a claim or sentence subsequent to words such as “including,” “comprising,” or their variants, mean “one or more.”

The term “actual shot point” as used herein means a time or location at which an impulsive source activation actually occurs during a marine seismic survey.

The term “nominal shot point” as used herein means a pre-plot specified time or location at which an impulsive source is nominally to be activated during a marine seismic survey. A given actual shot point may differ from a corresponding nominal shot point by the amount of an imposed dither, if any, and/or because of minor variations caused by equipment error and/or by prevailing conditions in the survey environment.

The term “cyclic source group” as used herein means a set of three or more impulsive marine seismic sources that are activated in sequential activation cycles in a manner such that a nominal shot point occurs for each source in the set exactly once during each activation cycle, and such that the sources in the group are nominally activated in the same sequence in each activation cycle.

The term “nominal shot point interval” as used herein means an interval between any two immediately sequential nominal shot points specified in a pre-plot for a cyclic source group. Such an interval may be measured in units of time or distance. Thus, for example, in a cyclic source group that employs a repeating S1, S2, S3 activation cycle, a nominal shot point interval may refer to the interval between an S1 nominal shot point and an S2 nominal shot point in the same activation cycle, between an S2 nominal shot point and an S3 nominal shot point in the same activation cycle, or between an S3 nominal shot point in one cycle and an S1 nominal shot point in the next cycle.

The phrases “apply a dither” or “impose a dither” and their variants as used herein mean adding a dither to a nominal shot point. As was mentioned above, applying a dither to a nominal shot point results in an actual shot point that differs from the nominal shot point by the amount of the applied dither, plus any minor variations caused by equipment error and/or by prevailing conditions in the survey environment. Although the latter minor variations are sometimes referred to in the industry as “natural dither,” activating a source at a nominal shot point without affirmatively adding a dither to the nominal shot point prior to the activation does not constitute “applying a dither” or “imposing a dither” as those terms are used herein, even if the actual shot so produced varies from the nominal shot point by the amount of a natural dither. An imposed dither may correspond to any positive or negative dither value in any range, and whose value may be indicated in temporal terms (e.g., a time value) or in spatial terms (e.g., a distance value). An imposed dither may or may not correspond to a random value. For a source to which dithering is not imposed during a survey, the actual shot points for the source will coincide with the nominal shot points specified in the pre-plot for that source with the exception of the just-described minor variations caused by equipment error and/or by prevailing conditions in the survey environment.

The term “shot line” as used herein means a path along which shots for a given source occur during a marine seismic survey.

### Marine Seismic Surveys Generally

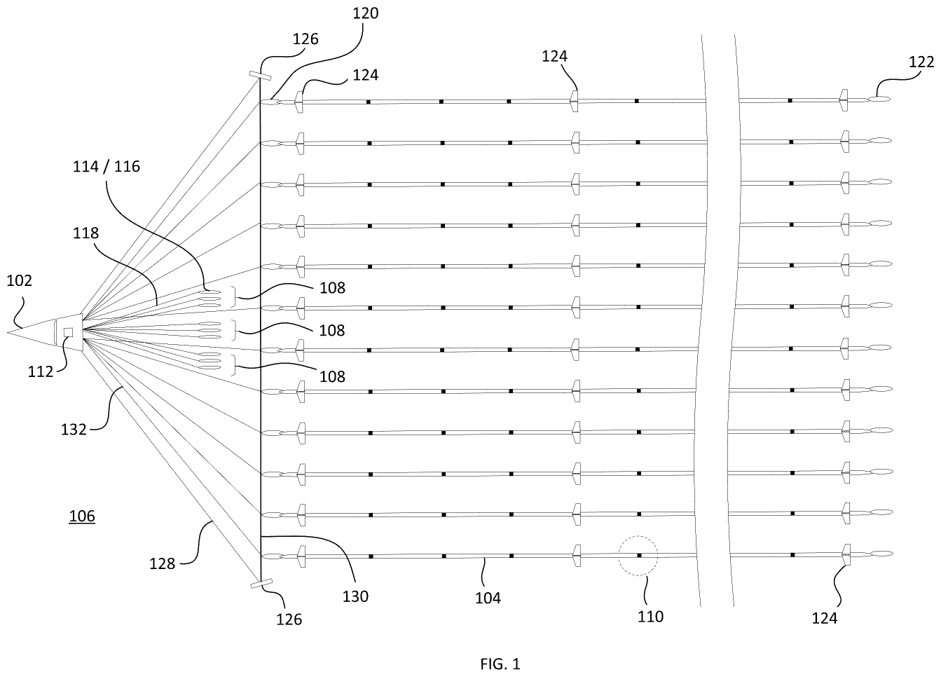

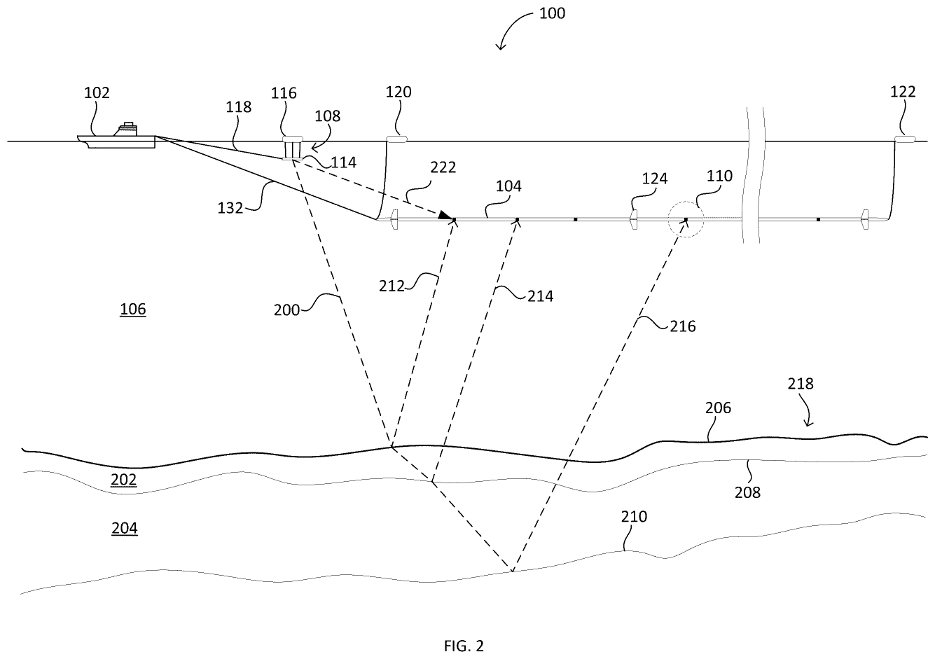

FIGS. 1 and 2 present top and side views, respectively, of an example towed streamer marine seismic survey system that employs impulsive seismic sources. Survey system 100 is representative of a variety of similar geophysical survey systems in which a vessel 102 tows an array of elongate sensor streamers 104 in a body of water 106 such as an ocean, a sea, a bay, or a large lake. Typically the vessel is equipped with at least one global positioning system (“GPS”) unit so that its location during the survey may be known and recorded for later use. Vessel 102 is shown towing twelve streamers 104 in the illustrated example. In other embodiments, any number of streamers may be towed, from as few as one streamer to as many as twenty or more. The terms “streamer” and “cable” as used herein should be interpreted to include any type of seismic sensor cable, and the two terms may be used interchangeably below.

During a typical marine seismic survey, one or more impulsive seismic sources 108 are activated to produce acoustic energy 200 that propagates in body of water 106. Energy 200 penetrates various layers of sediment and rock 202, 204 underlying body of water 106. As it does so, it encounters interfaces 206, 208, 210 between materials having different physical characteristics, including different acoustic impedances. At each such interface, a portion of energy 200 is reflected upward while another portion of the energy is refracted downward and continues toward the next lower interface, as shown. Reflected energy 212, 214, 216 is detected by sensors 110 disposed at intervals along the lengths of streamers 104, along with a so-called direct wavefield that reaches the sensors via a path, such as path 222, that travels directly from the impulsive sources 108 to the location of the sensors. In FIGS. 1 and 2, sensors 110 are indicated as black squares inside each of streamers 104. Sensors 110 produce signals corresponding to the reflected energy. These signals are collected and recorded by control equipment 112 located onboard vessel 102. The recorded signals may be processed and analyzed onboard vessel 102 and/or at one or more onshore data centers to produce images of structures within subsurface 218. These images can be useful, for example, in identifying possible locations of hydrocarbon reservoirs within subsurface 218 or in identifying favorable locations within subsurface 218 for the installation of new structures such as foundations for wind turbines.

Any number from three or more impulsive sources 108 may be used in a marine seismic survey in accordance with embodiments. In the illustrated example, vessel 102 is shown towing three such sources. In other systems, different numbers of sources may be used such as quad source or penta source configurations, and the sources may be towed by other vessels, which vessels may or may not tow additional streamer arrays. Typically, an impulsive source 108 includes one or more source subarrays 114, and each subarray 114 includes one or more acoustic emitters such as air guns. (Depending on the survey type, other types of sources may also be present, such as sparkers, boomers, or marine vibrators.) Each subarray 114 may be suspended at a desired depth from a subarray float 116. Compressed air as well as electrical power and control signals may be communicated to each subarray via source umbilical cables 118. Data may be collected, also via source umbilical cables 118, from various sensors located on subarrays 114 and/or floats 116, such as acoustic transceivers and GPS units. Acoustic transceivers and GPS units so disposed help to accurately determine the positions of each subarray 114 during a survey. In some cases, subarrays 114 may be equipped with steering devices to better control their positions during the survey.

In the context of surveys related to the prospection of hydrocarbon reservoirs, streamers 104 are often very long—on the order of 5 to 10 kilometers or longer—so usually are constructed by coupling numerous shorter streamer sections together. For site surveys such as those related to the installation of wind turbines, the streamers are typically much shorter—on the order of 100 to 500 meters, depending on the water depth.

In either case, each streamer 104 may be attached to a dilt float 120 at its proximal end (the end nearest vessel 102) and to a tail buoy 122 at its distal end (the end farthest from vessel 102). Dilt floats 120 and tail buoys 122 may be equipped with GPS units as well, to help determine the positions of each streamer 104 relative to an absolute frame of reference such as the earth. Each streamer 104 may in turn be equipped with acoustic transceivers and/or compass units to help determine their positions between GPS units and/or relative to one another. In many survey systems 100, streamers 104 include steering devices 124 attached at intervals, such as every 300 meters. Steering devices 124 typically provide one or more control surfaces to enable moving the streamer to a desired depth, or to a desired lateral position, or both. Paravanes 126 are shown coupled to vessel 102 via tow ropes 128. As the vessel tows the equipment, paravanes 126 provide opposing lateral forces that straighten a spreader rope 130, to which each of streamers 104 is attached at its proximal end. Spreader rope 130 helps to establish a desired crossline spacing between the proximal ends of the streamers. Power, control, and data communication pathways are housed within lead-in cables 132, which couple the sensors and control devices in each of streamers 104 to the control equipment 112 onboard vessel 102.

Collectively, the array of streamers 104 forms a sensor surface at which acoustic energy is received for recording by control equipment 112. In many instances, it is desirable for the streamers to be maintained in a straight and parallel configuration to provide a sensor surface that is generally flat, horizontal, and uniform. In other instances, an inclined and/or fan shaped receiving surface may be desired and may be implemented using control devices on the streamers such as those just described. Other array geometries may be implemented as well. Prevailing conditions in body of water 106 may cause the depths and lateral positions of streamers 104 to vary at times. In various embodiments, streamers 104 need not all have the same length and need not all be towed at the same depth or with the same depth profile.

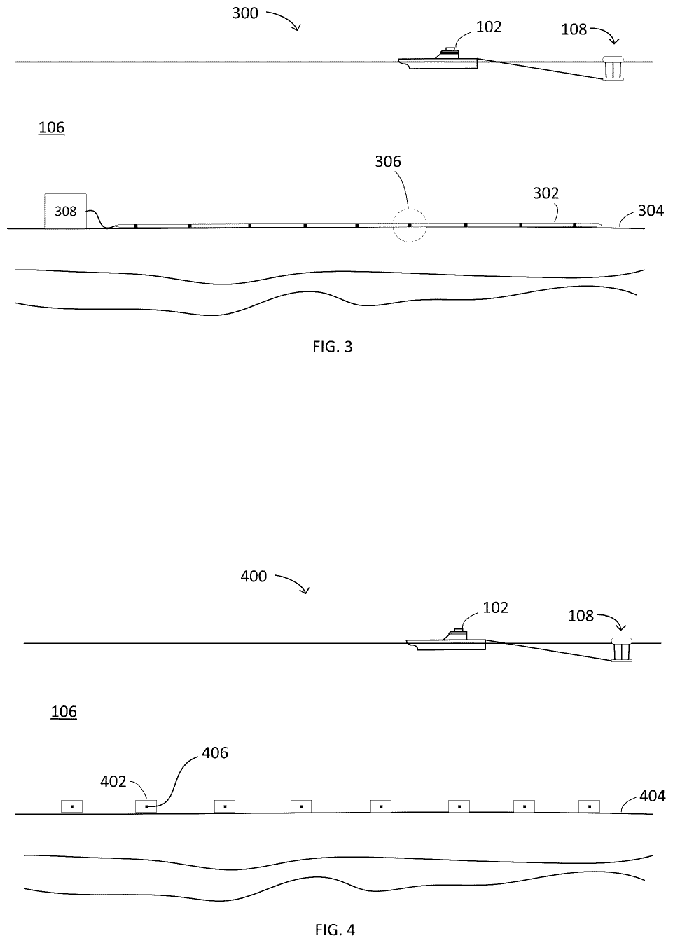

FIG. 3 illustrates an example ocean bottom cable survey system 300, in which a vessel 102 tows one or more sources 108 over an installation of one or more ocean bottom cables 302, each of which is disposed on a water bottom 304. Each cable 302 may include one or more sensors or sensor groups 306 disposed along its length, generally as shown. In turn, each of the cables may be coupled to a manifold 308 in which signals from the sensors may be aggregated and either stored or transmitted to a collection point, or both. In some surveys, the cables may be suspended within the water column.

FIG. 4 illustrates an example ocean bottom node survey system 400, in which a vessel 102 tows one or more sources 108 over an installation of one or more ocean bottom nodes 402, each of which is disposed on a water bottom 404. Each node 402 may include one or more sensors or sensor groups 406 as shown. Signals generated by the sensors or sensor groups may be collected in the nodes for later retrieval, or may be transmitted to a collection point, or both. In some surveys, the nodes may float on or below the water surface.

Techniques to be described herein may be employed in the context of any of the above or similar types of marine seismic surveys, as well as in other types of marine seismic surveys.

### Geophysical Sensors in Marine Seismic Surveys

Each of sensors 110, 306, 406 may include one or more different sensor types such as pressure sensors (e.g., hydrophones) and/or motion sensors. Examples of motion sensors include velocity sensors (e.g., geophones) and acceleration sensors (e.g., accelerometers) such as micro-electromechanical system (“MEMS”) devices. In general, pressure sensors provide a magnitude-only, or scalar, measurement. This is because pressure in seismic applications is generally not associated with a direction and is therefore regarded as a scalar quantity. Motion sensors such as velocity sensors and acceleration sensors, however, each provide a vector measurement that includes both a magnitude and, at least implicitly, a direction, as velocity and acceleration are both vector quantities. Velocity sensors and acceleration sensors each may be referred to herein as “motion sensors.”

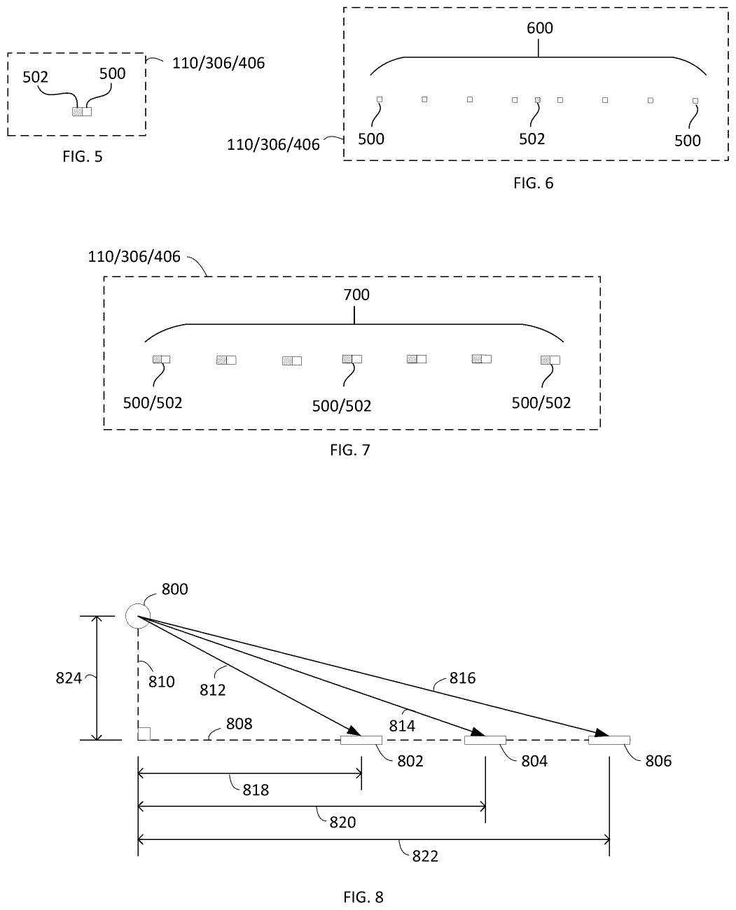

FIGS. 5-7 schematically illustrate example groupings of seismic sensors suitable for use in any of the survey types described above. In the arrangement of FIG. 5, each sensor location comprises a single pressure sensor 500 collocated with a single motion sensor 502. In the arrangement of FIG. 6, each sensor location comprises a set of pressure sensors 500 forming a single pressure sensor group 600. A motion sensor 502 is disposed substantially at the center of pressure sensor group 600. (It is also possible to employ a similar arrangement in which a single pressure sensor is disposed among a group of motion sensors.) Typically, the signals generated by sensors forming a sensor group are combined or aggregated in some way, such as by summation and/or averaging. Such combination or aggregation may be accomplished in any suitable manner, such as in an analog domain using appropriate electrical coupling, or in a digital domain using digital data processing. In general, a sensor group may include any number of sensors and may comprise either pressure sensors or motion sensors. Normally, however, only measurements of the same type in a group (e.g., pressure, velocity, or acceleration) would be subject to combination or aggregation. Thus, in the particular arrangement illustrated in FIG. 6, the measurements of pressure sensors 500 may be combined or aggregated into a single signal, while the measurements of motion sensor 502 would be preserved as a separate signal. In the arrangement of FIG. 7, each sensor location comprises a group 700 of collocated pressure sensors 500 and motion sensors 502. In the latter arrangement, one aggregated signal can be generated from the pressure sensors in the group, while another aggregated signal can be generated from the motion sensors in the group. Various other permutations of the arrangements of FIGS. 5, 6 and 7 are also possible. For example, any of these arrangements may comprise pressure sensors only or motion sensors only.

### Offsets in Marine Seismic Surveys

FIG. 8 is provided to illustrate the concept of offset in marine seismic surveys. In the figure, circle 800 represents a source, while each of rectangles 802, 804, 806 represents a sensor or sensor group. For example, sensors or sensor groups 802-806 may represent sensors disposed along the length of a single streamer 104, or may represent sensors in distinct seismic nodes or sensors disposed within an ocean bottom cable. Dashed line 808 depicts an inline direction. Dashed line 810 depicts a crossline direction orthogonal to the inline direction. Typically, a vessel towing a source would follow a sail path parallel to inline direction 808.

The distance between a source and any one sensor or sensor group constitutes an offset. Such an offset may be measured from the source to a single sensor, or to any one of the sensors within a sensor group, or to the center of a sensor group. Three different example offsets are illustrated in the drawing, ranging in length from a smallest offset 812, to an intermediate length offset 814, to a largest offset 816. A distance along the straight line path between a source and a given sensor or sensor group, as depicted by arrows 812-816, is commonly referred to as a “seismic offset” or simply an “offset.” A distance along direction 808 between a source and the inline projection of a sensor or sensor group is commonly referred to as an “inline offset.” Thus, sensor or sensor group 802 defines a smallest inline offset 818 with respect to source 800, sensor or sensor group 804 defines an intermediate length inline offset 820 with respect to the source, and sensor or sensor group 806 defines a largest inline offset 822 with respect to the source. Similarly, a distance along direction 810 between a sensor or sensor group and the crossline projection of the source is commonly referred to as a “crossline offset.” In the illustrated example, each of sensors or sensor groups 802-806 defines the same crossline offset 824 with respect to source 800.

The term “offset” as used herein refers to any of the above-described distances.

### Orthogonality and its Utility in Deblending

Because sensors in streamers are spaced apart in an inline direction along the streamers (i.e., at different inline offsets), reflected energy from a source disposed forward of a streamer spread will propagate down the sensors in each streamer in the aft direction, while reflected energy from a source disposed aft of a streamer spread will propagate down the sensors in each streamer in the forward direction. Similarly, reflected energy from a source disposed on the starboard side of a streamer spread midline (i.e., at a crossline offset from the midline) will propagate across sensors in adjacent streamers in a crossline direction from starboard to port, while reflected energy from a source disposed on the port side of a streamer spread midline will propagate across sensors in adjacent streamers in a crossline direction from port to starboard. These phenomena may all be referred to as “orthogonal moveout,” or simply “orthogonality.”

The phenomenon of orthogonality may be exploited when energy attributable to one or more sources in a first location must be separated from energy attributable to one or more sources in a second location. That is, inline moveout filtering may be employed to isolate forward source energy from aft source energy, and crossline moveout filtering may be employed to isolate starboard source energy from port source energy. While conventional techniques for separating source energy often require imposing strict timing constraints between the activations of the various sources whose energy must be de-blended, the availability of orthogonality in deblending enables relaxation of such strict timing constraints between the activations of the sources. According to this technique, the so-called “pop” intervals between activations of the sources may be reduced, thereby increasing the number of source activations per unit time. The increase in source activations per unit time enables more data points to be gathered per unit distance and thereby contributes to increased resolution in the images produced from the survey data.

### Example Computer System

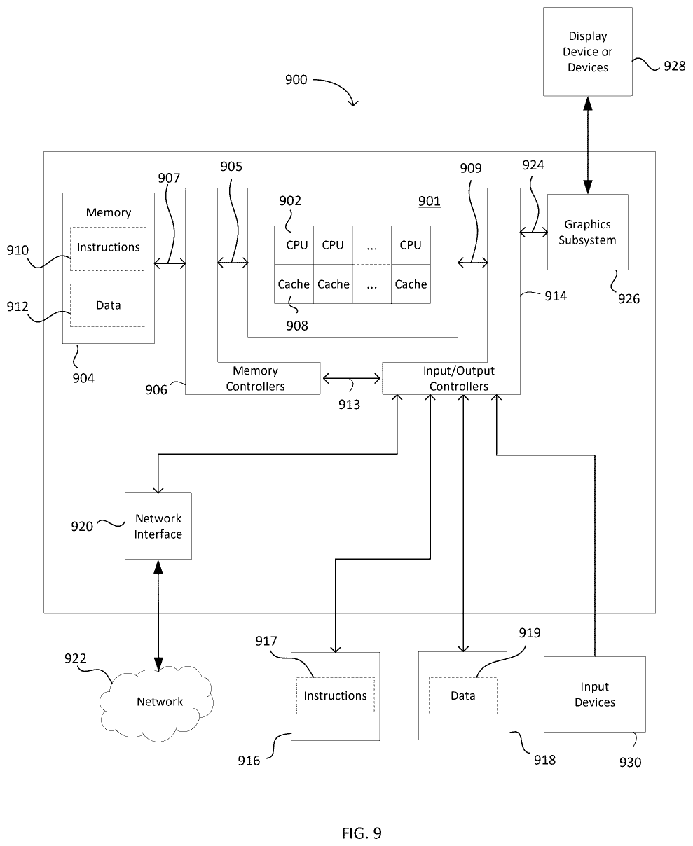

Various types of computing devices may be used in conjunction with embodiments. FIG. 9 is a block diagram logically illustrating a representative example of such a computer system 900 that may be used to perform any of the methods described herein or to implement equipment described herein. For example, a computing device such as computer system 900 may be used to execute survey instructions stored in a non-transitory computer readable medium to control equipment during the performance of a marine seismic survey, to manufacture geophysical data products as described herein, to control the activations of sources in a cyclic source group during a survey, and/or to de-blend data gathered during a marine seismic survey. Persons having skill in the art and having reference to this disclosure will appreciate that suitable computer system architectures may vary and that alternative or additional types of computing devices may also be employed in conjunction with any of the embodiments described herein. Computer system 900 is therefore shown by way of example and not by way of limitation.

Computer system 900 includes a core/cache complex 901 that contains one or more central processor unit (“CPU”) cores 902, each of which is associated with one or more levels of high-speed cache memory 908. The core/cache complex is in turn coupled to one or more high-speed memory controllers 906, as indicated at 905, and to one or more input/output controllers 914, as indicated at 909. The memory controllers and the input/output controllers may additionally be coupled to one another via one or more high-speed interconnects 913.

The memory controllers may be coupled to a system memory 904 by any suitable means, such as via a high-speed memory bus 907. The memory controllers facilitate interactions between the system memory and the core/cache complex as well as between the system memory and the input/output controllers. System memory 904 typically comprises a large array of random-access memory locations, often housed in multiple dynamic random-access memory (“DRAM”) devices, which in turn may be housed in one or more dual inline memory module (“DIMM”) packages, as shown. Each core 902 can execute computer-readable instructions 910 stored in the system memory, and can thereby perform operations on data 912, also stored in the system memory.

The input/output controllers may be coupled to respective subsystems as indicated in the drawing. Non-limiting examples of such subsystems include a graphics subsystem 926, a network interface 920, one or more non-transitory computer-readable media such as computer-readable medium 916 and computer-readable medium 918.

Network interface 920 may facilitate interactions between components of the computer system and an external network 922. Non-limiting examples of network 922 include a local area network, a wide area network, the Internet, or any combination of these.

Non-limiting examples of non-transitory computer-readable media include so-called solid-state disks (“SSDs”), spinning-media magnetic disks, optical disks, flash drives, magnetic tape, and the like. The storage media may be permanently attached to the computer system or may be removable and portable. In the example shown, medium 916 has instructions 917 (software) stored therein, while medium 918 has data 919 stored therein. Operating system software executing on the computer system may be employed to enable a variety of functions, including transfer of instructions 910, 917 and data 912, 919 back and forth between the storage media and the system memory.

In embodiments that include a graphics subsystem, one or more of the input/output controllers may be coupled to the graphics subsystem by any suitable means, such as by a high-speed bus 924. The graphics subsystem may in turn be coupled to one or more display devices 928. While display devices 928 may be located in physical proximity to the rest of the components of the computer system, they may also be remotely located. Software running on the computer system may generate instructions or data that cause the graphics subsystem to display images, data, and/or user interface elements on display devices 928. Such software may also generate instructions or data that cause the display of such elements on one or more remotely located display devices (for example, display devices attached to a remotely located computer system) by sending the instructions or data over network 922 using an appropriate network protocol. The graphics subsystem may comprise one or more graphics processing units (“GPUs”) to accelerate the execution of instructions or to implement any of the methods described herein.

Computer system 900 may represent a single, stand-alone computer workstation that is coupled to input devices 930 such as a keyboard and pointing device. It may also represent one of the nodes in a larger, multi-node or multi-computer system such as a cluster, in which case access to its computing capabilities may be provided by software that interacts with and/or controls the cluster. Nodes in such a cluster may be co-located in a single data center or may be distributed across multiple locations or data centers in distinct geographic regions. Furthermore, computer system 900 may represent an access point from which such a cluster or multi-computer system may be accessed and/or controlled. Any of these or their components or variants may be referred to herein with phrases such as “computing apparatus,” a “computing device,” or a “computer system.”

In example embodiments, data 919 may correspond, for example, to sensor measurements or other data recorded during a marine geophysical survey, or may correspond to survey plan instructions for implementing any of the surveys described herein, or may correspond to data such as de-blended signals that are derived from sensor measurements. Instructions 917 may correspond to instructions for performing any of the methods described herein. In such embodiments, instructions 917, when executed by one or more computing devices such as one or more of CPU cores 902, cause the computing device to perform operations described herein on the data, producing results that may be stored in one or more non-transitory computer-readable media such as medium 918. In such embodiments, medium 918 constitutes a geophysical data product that is manufactured by using the computing device to perform methods described herein and by storing the results in the medium.

Geophysical data product 918 may be stored locally or may be transported to other locations where further processing and analysis of its contents may be performed. If desired, a computer system such as computer system 900 may be employed to transmit the geophysical data product electronically to other locations via a network interface 920 and a network 922 (e.g., the Internet). Upon receipt of the transmission, another geophysical data product may be manufactured at the receiving location by storing contents of the transmission, or processed versions thereof, in another non-transitory computer readable medium. Similarly, geophysical data product 918 may be manufactured by using a local computer system 900 to access one or more remotely-located computing devices in order to execute instructions 917 remotely, and then to store results from the computations on a medium 918 that is attached either to the local computer or to one of the remote computers. The word “medium” as used herein should be construed to include one or more of such media.

### Example Activation Patterns for Cyclic Source Groups

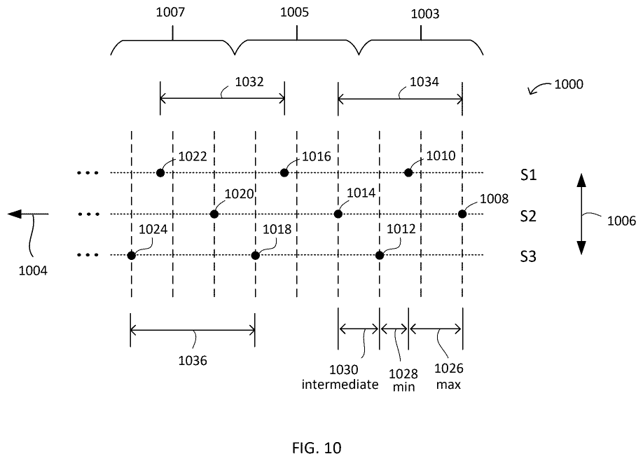

Several illustrative example activation patterns for cyclic source groups will now be described with reference to FIGS. 10-16. Each example activation pattern features irregular nominal shot point intervals—a departure from conventional approaches, which have uniformly employed regular nominal shot point intervals. In various embodiments, such irregular nominal shot point intervals may be used to create datasets on which deblending techniques produce better results than those achievable on conventionally created datasets. Accordingly, embodiments may be used to enhance fold and sampling density generally in surveys that employ them. For example, they may be used to add fold and sampling density to the datasets of 4D monitor surveys relative to the fold and sampling density of the baseline surveys they repeat.

Each of the examples includes a set of three or more impulsive sources arranged in a cyclic source group. The sources in the set are activated in sequential activation cycles. The activation cycles are such that exactly one nominal shot point occurs for each of the sources in the set during each activation cycle, and such that all nominal shot points within a given activation cycle are distinct. Pairs of immediately sequential nominal shot points within each activation cycle and across sequential activation cycles define respective nominal shot point intervals. At least two of the nominal shot point intervals are unequal. Thus, the nominal shot point intervals for the cyclic source group are irregular. Despite the irregularity in the nominal shot point intervals, however, the nominal shot points for each individual source in the source group occur at regular intervals. Thus, common midpoint (“CMP”) coverage is preserved over each sail line relative to the CMP coverage produced using conventional techniques.

Also in each of the examples, nominal shot points for at least one of the sources in the group are translated either forward or backward in the inline direction relative to those in conventional approaches that employ regular shot point intervals. Nevertheless, because a nominal shot point occurs for each of the sources in each cycle, and because the nominal shot points for each individual source in the group occur at regular intervals, fold and sampling density are preserved for all CMP bins relative to the CMP bins of conventional approaches. Moreover, this is the case even for the sources whose nominal shot points have been translated forward or backward in the inline direction relative to those in a conventional activation pattern.

In each example, nominal shot points for one or more sources that are closest to one another in the crossline direction may be translated forward or backward in the inline direction to create longer clean shot records for those sources. Doing so may eliminate the need for deblending for those sources, or in any event may reduce the amount of deblending required for those sources. Nominal shot points for one or more sources that are farthest from one another in the crossline direction may be translated forward or backward in the inline direction such that the clean shot record associated with those sources is shortened. In the latter cases, orthogonality is created by the greater crossline distance between the sources with the shortened clean shot records. This crossline orthogonality may be exploited for improved deblending of the resulting dataset, so that the energy presented by each respective source in the blended shot record may be more effectively separated.

In some of the examples, one or more of the sources in the cyclic source group are used to reproduce, during a 4D monitor survey, the actual shot lines from a baseline survey, while additional sources are used during the monitor survey relative to the number of sources used in the prior survey. In this way, the monitor survey is able to provide better fold and sampling density than were present in the baseline survey, while still repeating all of the shot lines of the baseline.

In each of FIGS. 10-16, one or more controllers are configured to activate sources in a cyclic source group in sequential activation cycles while a vessel tows the sources in an inline direction 1004. Each source is towed at an offset from the others in a crossline direction 1006. In the drawings, small-dash horizontal lines indicate distinct crossline positions (and corresponding shot lines) for each of the respective sources, while large-dash vertical lines indicate regular shot point intervals that would occur in a conventional source group as the sources are towed in the inline direction. In each case, nominal shot points for sources are indicated with dark circles or with stars, as will be described further below. For each embodiment, one or more controllers such as control equipment 112 or a computer system 900 may be configured to activate the sources according to the activation cycles shown while a vessel tows the sources in the inline direction. The vessel that tows the cyclic source group may or may not also tow one or more seismic streamers.

In some embodiments, the sources in a cyclic source group may be towed equidistant from one another in the crossline direction. In other embodiments, the sources need not be disposed equidistant in the crossline direction. In any embodiments, the sources in a cyclic source group may all occupy a same inline position relative to the other sources in the same cyclic source group, or the sources in the group may be towed such that some or all of them occupy different inline positions.

In some embodiments, the controller(s) may impose a dither on the nominal shot points for some or all of the sources in the cyclic source group. Such imposed dithers may or may not be random dithers.

Referring now to example of FIG. 10, a cyclic source group 1000 is shown. Cyclic source group 1000 consists of three impulsive sources S1, S2, S3 towed equidistant from one another and disposed at distinct crossline positions such that S2 is between S1 and S3 in the crossline direction. One or more controllers activate the sources in sequential activation cycles 1003, 1005, 1007. Because the sources are towed in inline direction 1004, activation cycle 1003 occurs first. Activation cycle 1003 is followed immediately by activation cycle 1005, which itself is followed by activation cycle 1007, and so on to the left as the sail line proceeds. As can be seen from the drawing, in each activation cycle, exactly one (i.e., one and only one) nominal shot point occurs for each of the sources in the group, and all of the nominal shot points within a cycle are distinct (i.e., each occurs at a different time or location than the others).

Nominal shot points occur for the sources in a sequence S2, S1, S3 during each activation cycle. Thus, a sequence of nominal shot points is established comprising nominal shot points 1008, 1010, 1012, 1014, 1016, 1018, 1020, 1022, and 1024. Nominal shot point interval 1026 occurs between the pair of nominal shot points 1008, 1010 specified in the pre-plot for sources S2 and S1, respectively, within the activation cycle. Nominal shot point interval 1028 occurs between the pair of nominal shot points 1010, 1012 specified for sources S1 and S3, respectively, within the activation cycle. Nominal shot point interval 1030 occurs between the pair of nominal shot points 1012, 1014 specified for sources S3 and S2, respectively, that spans sequential activation cycles 1003 and 1005.

The sizes of shot point intervals 1026, 1028, and 1030 are unequal. Specifically, the size of nominal shot point interval 1026 corresponds to a maximum nominal shot point interval for the activation cycle, the size of shot point interval 1028 corresponds to a minimum nominal shot point interval for the activation cycle, and the size of shot point interval 1030 corresponds to an intermediate shot point interval smaller than the maximum but larger than the minimum. Notably, maximum shot point interval 1026 occurs between sources that are disposed at the closest crossline offset from one another among the sources in the set. Specifically, it occurs between source S2 and S1, which are disposed crossline adjacent to one another. Minimum shot point interval 1028 occurs between sources that are disposed at the farthest crossline offset from one another among the sources in the set. Specifically, it occurs between sources S1 and S3, which are disposed at opposite crossline extremes within the source group. Accordingly, cyclic source group 1000 achieves the advantages described above by lengthening the clean shot record durations between the closely located source pair S2/S1 and shortening the clean shot record duration between the distantly located source pair S1/S3.

The large-dash vertical lines in FIG. 10 indicate where nominal shot points would be located in a conventional triple source survey that employs regular nominal shot point intervals. Notably, the nominal shot points for S1 in group 1000 are translated forward in the inline direction relative to those of conventional surveys. Nevertheless, all of the nominal shot points corresponding to each of the individual sources in source group 1000 occur at regular intervals 1032, 1034, 1036. Specifically, the nominal shot points for source S1 occur at repeating intervals 1032, the nominal shot points for source S2 occur at repeating intervals 1034, and the nominal shot points for S3 occur at repeating intervals 1036. All of regular intervals 1032, 1034, 1036 have the same length. Thus, CMP coverage is preserved despite the inline translation of the nominal shot points for S1 relative to those of conventional triple source surveys.

A cyclic source group such as group 1000 may be used, for example, in any triple source survey for which high sampling density, uniform CMP coverage, and enhanced deblending are desired.

Referring now to FIG. 11, a cyclic source group 1100 is shown. Each of sources S1, S2, S3 in group 1100 occupies a distinct crossline position, with S2 disposed between S1 and S3 in the crossline position. One or more controllers activates the sources in sequential activation cycles 1103, 1105, 1107 in a sequence S2, S1, S3. Cyclic source group 1100 is similar to cyclic source group 1000 except that, in cyclic source group 1100, the nominal shot points for both of sources S1 and S3 have been translated in the inline direction relative to those of conventional surveys that employ regular nominal shot point intervals (as indicated by the large-dash vertical lines). Specifically, the nominal shot points for S1 are translated forward in the inline direction, and the nominal shot points for S3 are translated backward in the inline direction. As in source group 1000, however, the nominal shot points for each of the individual sources in cyclic source group 1100 occur at regular intervals. For example, nominal shot points 1110, 1116, 1122 for S1 occur at regular intervals, nominal shot points 1108, 1114, 1120 for S2 occur at regular intervals, and nominal shot points 1112, 1118, 1124 for S3 occur at regular intervals.

The result is that a maximum nominal shot point interval 1126 is established between nominal shot points for the pair of sources S2/S1 that are closest to one another in the crossline direction (see, for example, nominal shot points 1108 and 1110). Meanwhile, a minimum nominal shot point interval 1128 is established between nominal shot points for the pair of sources S1/S3 that are located farthest from one another in the crossline direction (see, for example, nominal shot points 1110 and 1112). In some embodiments, shot point interval 1130 (e.g., between nominal shot points 1112 and 1114) may also correspond to the maximum. In other embodiments, interval 1130 need not be equal to interval 1126.

As is the case with cyclic source group 1000, a cyclic source group such as group 1100 may be used, for example, in any triple source survey for which high sampling density, uniform CMP coverage, and enhanced deblending are desired.

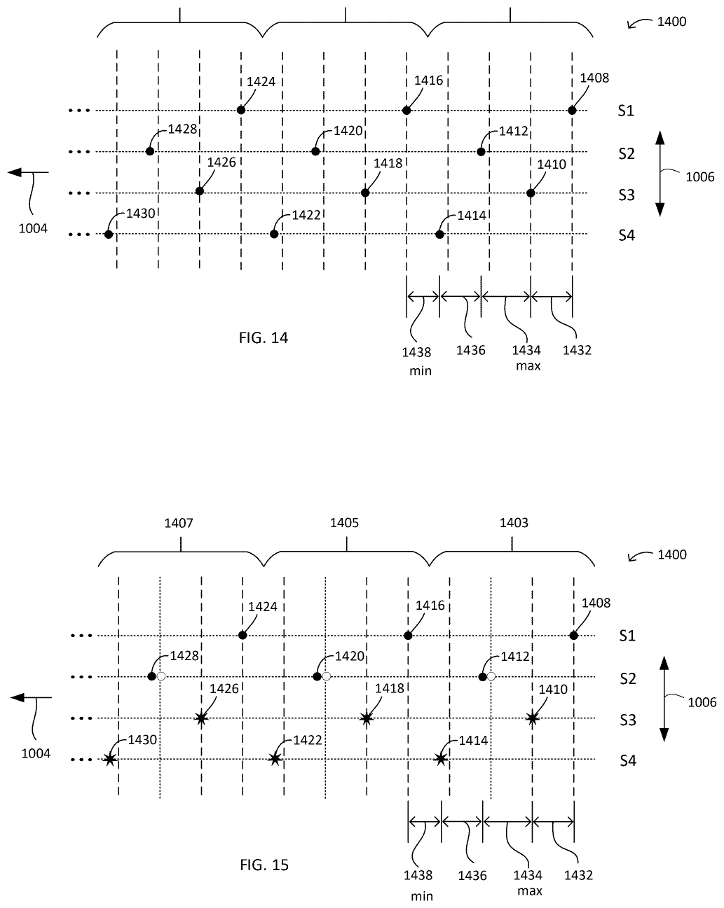

Referring for the moment now to FIG. 14, a cyclic source group 1400 will be described in which four sources S1, S2, S3, and S4 are employed. The sources in group 1400 are disposed equidistant from one another at distinct crossline positions (indicated by the small-dash horizontal lines) such that S2 is adjacent to S1 in the crossline direction and S3 is adjacent to S4 in the crossline direction, with sources S1 and S4 disposed at respective crossline outermost positions. One or more controllers activate the sources in sequential activation cycles 1403, 1405, 1407, such that nominal shot points occur in a sequence S1, S3, S2, S4 during each activation cycle.

As in the previous examples, large-dash vertical lines in FIG. 14 indicate nominal shot point positions as they would occur in a conventional quad-source survey that employs regular nominal shot point intervals. Also as in the previous examples, the nominal shot points for each individual source in group 1400 occur at regular intervals. For example, nominal shot points for S1 occur at 1408, 1416, and 1424. Nominal shot points for S2 occur at 1412, 1420, and 1428. Nominal shot points for S3 occur at 1410, 1418, 1426. And nominal shot points for S4 occur at 1414, 1422, and 1430. While the nominal shot points for S1 and S3 coincide with the large-dash vertical lines, the nominal shot points for S2 and S4 have been translated forward in the inline direction relative to those of conventional quad-source surveys. As a result, a maximum nominal shot point interval 1434 is established between the pair of sources S3/S2 that are located closest to one another in the crossline direction, while a minimum nominal shot point interval 1438 is established between the pair of sources S4/S1 that are located farthest from one another in the crossline direction. Intervals 1432 and 1436 have intermediate lengths and may or may not be equal in various embodiments.

The example of FIG. 14 achieves the advantages described above by lengthening the clean shot record durations between the closely located source pair S3/S2 and by shortening the clean shot record duration between the distantly located source pair S4/S1. Thus, a cyclic source group such as group 1400 may be used, for example, in any quad source survey for which high sampling density, uniform CMP coverage, and enhanced deblending are desired.

While FIGS. 10, 11, and 14 illustrate example cyclic source groups consisting of three or four sources, persons having skill in the art and having reference to this disclosure will appreciate that further example cyclic source groups having similar advantages may be created that use five or more sources, and that additional three- or four-source groups can be created that differ from the examples given but nevertheless exhibit the advantageous features described above.

### Repeating a Previous Survey While Adding Fold and Sampling Density

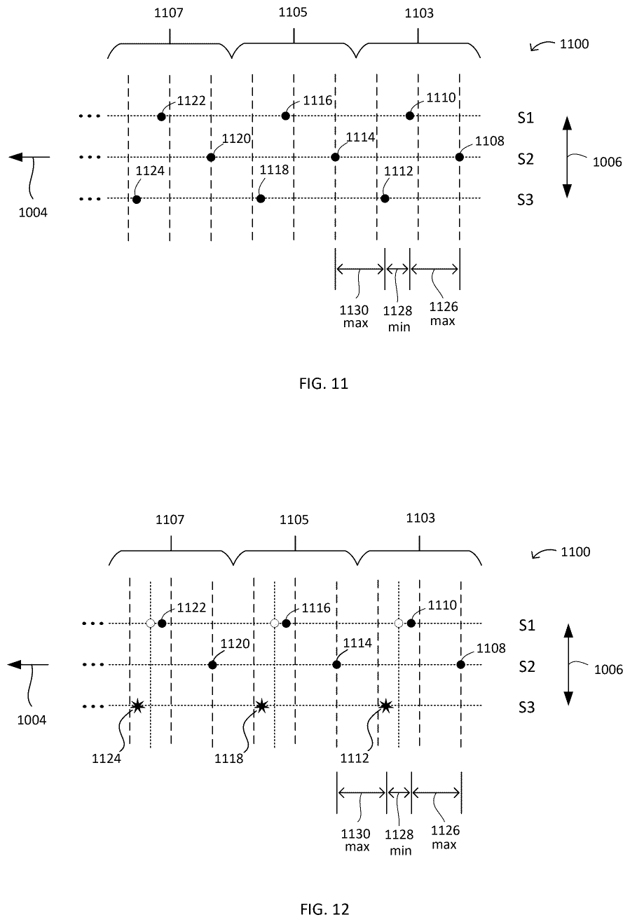

In various embodiments, cyclic source groups such as those described above may be used to repeat, during a 4D monitor survey, the actual shot lines of a baseline survey while at the same time preserving the CMP coverage and enhancing fold and sampling density relative to that of the baseline survey. Several illustrative examples of such embodiments will now be described in relation to FIGS. 12, 13, 15, and 16.

FIG. 12 illustrates a first example way in which a triple-source cyclic source group in accordance with that of FIG. 11 may be used in a 4D monitor to repeat some of the actual shot points and all of the shot lines of a conventional dual-source baseline survey. In such a configuration, two sources in the monitor survey source group comprise “repeat” sources. For example, in the example of FIG. 12, a repeat source S2 may be used to repeat actual shot points from the port side source of the baseline survey, while a repeat source S1 may be used to repeat the starboard source shot line of the baseline survey.

Light colored circles in the S1 shot line of FIG. 12 indicate actual shot points of the starboard side source from the baseline survey, while the dark colored circles indicate nominal shot points for S1 in the monitor survey. Dark colored circles in the S2 shot line of FIG. 12 indicate both the actual shot points of the port side source from the baseline survey and nominal shot points for S2 in the monitor survey. Stars in the S3 shot line of FIG. 12 indicate nominal shot points for S3 in the monitor survey. Stars are used here for S3 rather than circles simply to indicate which of the three sources in the monitor survey comprises an “additional” source relative to the number of sources that were used in the baseline survey. In this case, S3 is the additional source.

As can be seen from the drawing, all nominal shot points of repeat source S1 in the monitor survey are translated backward in the inline direction relative to the corresponding shot points of the baseline survey, but each of them remains on the shot line of the starboard side baseline source. Thus, for the reasons explained above, repeat source S1 preserves the CMP coverage of the starboard baseline source, as well as the fold and sample density of that source, with the sole compromise that each nominal shot point of repeat source S1 is translated a small distance in the inline direction relative to a corresponding shot of the starboard baseline source.

Meanwhile, however, overall fold and sampling density for the monitor survey are enhanced relative to that of the baseline survey due to the addition of source S3 in the monitor survey. Moreover, for the reasons explained above, the dataset produced by the monitor survey provides enhanced results when a deblending process is applied to the dataset. In some embodiments, a dither may be applied to all of the nominal shot points of added source S3 during the performance of the monitor survey to further enhance deblending results. In still further embodiments, a dither may also be applied to all of the nominal shot points of repeat source S1, thus further enhancing deblending results. In embodiments for which it is desired to repeat actual shot points for the port baseline source, a dither is not applied to the nominal shot points of repeat source S2 during the monitor survey. In other embodiments, a dither may be applied to S2 if desired.

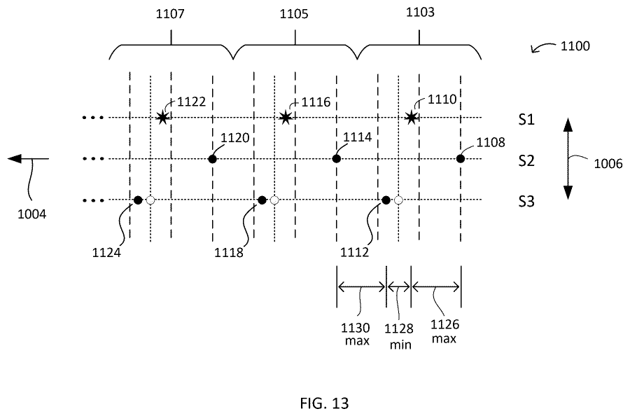

FIG. 13 illustrates a second example way in which a triple-source cyclic source group in accordance with that of FIG. 11 may be used in a 4D monitor to repeat some of the actual shot points and all of the shot lines of a conventional dual-source baseline survey. In such a configuration, two sources in the monitor survey source group comprise “repeat” sources. For example, in the example of FIG. 13, a repeat source S2 may be used to repeat actual shot points from the starboard side source of the baseline survey, while a repeat source S3 may be used to repeat the port source shot line of the baseline survey.

Light colored circles in the S3 shot line of FIG. 13 indicate actual shot points of the port side source from the baseline survey, while the dark colored circles indicate nominal shot points for S3 in the monitor survey. Dark colored circles in the S2 shot line of FIG. 13 indicate both the actual shot points of the starboard side source from the baseline survey and nominal shot points for S2 in the monitor survey. Stars in the S1 shot line of FIG. 13 indicate nominal shot points for S1 in the monitor survey. Stars are used here for S1 rather than circles simply to indicate which of the three sources in the monitor survey comprises an “additional” source relative to the number of sources that were used in the baseline survey. In this case, S1 is the additional source.

As can be seen from the drawing, all nominal shot points of repeat source S3 in the monitor survey are translated forward in the inline direction relative to the corresponding shot points of the baseline survey, but each of them remains on the shot line of the port side baseline source. Thus, for the reasons explained above, repeat source S3 preserves the CMP coverage of the port baseline source, as well as the fold and sample density of that source, with the sole compromise that each nominal shot point of repeat source S3 is translated a small distance in the inline direction relative to a corresponding shot of the port baseline source.

Meanwhile, however, overall fold and sampling density for the monitor survey are enhanced relative to that of the baseline survey due to the addition of source S1 in the monitor survey. Moreover, for the reasons explained above, the dataset produced by the monitor survey provides enhanced results when a deblending process is applied to the dataset. In some embodiments, a dither may be applied to all of the nominal shot points of added source S1 during the performance of the monitor survey to further enhance deblending results. In still further embodiments, a dither may also be added to all of the nominal shot points of repeat source S3, thus further enhancing deblending results. In embodiments for which it is desired to repeat actual shot points for the starboard baseline source, a dither is not applied to the nominal shot points of repeat source S2 during the monitor survey. In other embodiments, a dither may be applied to S2 if desired.

If desired, a similar monitor survey may be configured in accordance with cyclic source group 1000 of FIG. 10 to repeat a conventional dual source baseline survey. In the latter case, sources S1 and S2 may comprise repeat sources in the same manner as indicated in FIG. 13, and source S3 may comprise an additional source relative to the baseline survey. In some such embodiments, dithering may be added to the nominal shot points of source S3 for improved deblending results. In still further such embodiments, dithering may also be added to the nominal shot points for the inline-translated repeat source S1 for further improved deblending results. In embodiments for which it is desired to repeat actual shot points for the port baseline source, a dither is not applied to the nominal shot points of repeat source S2 during the monitor survey. In other embodiments, a dither may be applied to S2 if desired.

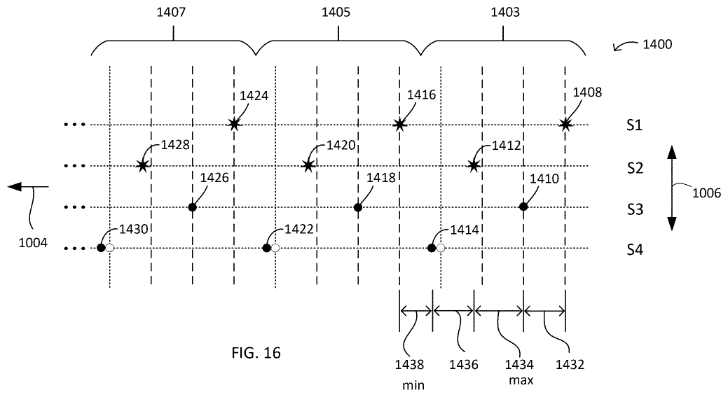

FIGS. 15 and 16 illustrate two example ways in which a quad-source cyclic source group in accordance with that of FIG. 14 may be used in a 4D monitor to repeat some of the actual shot points and all of the shot lines of a conventional dual-source baseline survey. As was the case in the examples of FIGS. 12 and 13, in the quad-source configurations, two sources in the monitor survey source group comprise repeat sources. One of the repeat sources may be used to repeat actual shot points from one of the two sources from the baseline survey, while the other repeat source may be used to repeat the shot line of the other of the two baseline sources.

In the example of FIG. 15, sources S1 and S2 are the repeat sources in the monitor survey, while sources S3 and S4 constitute additional sources relative to the number of sources used in the baseline survey. Thus, for the same reasons described above, stars are used in FIG. 15 to indicate nominal shot points for sources S3 and S4 in the monitor survey. Dark colored circles in the S1 shot line of FIG. 15 indicate both actual shot points from the starboard baseline source and nominal shot points for S1 in the monitor survey. Light colored circles in the S2 shot line of FIG. 15 indicate actual shot points of the port side source from the baseline survey, while dark colored circles indicate nominal shot points for S2 in the monitor survey.

As can be seen from the drawing, all nominal shot points of repeat source S2 in the monitor survey of FIG. 15 are translated forward in the inline direction relative to the corresponding shot points of the baseline survey, but each of them remains on the shot line of the port side baseline source. Thus, for the same reasons explained above, repeat source S2 preserves the CMP coverage of the port side baseline source, as well as the fold and sample density of that source, with the sole compromise that each nominal shot point of repeat source S2 is translated a small distance in the inline direction relative to a corresponding shot of the port baseline source.

Meanwhile, overall fold and sampling density for the monitor survey of FIG. 15 are enhanced relative to that of the baseline survey due to the addition of sources S3 and S4, which in this case are both disposed on the port side of the repeat sources. Moreover, for the reasons explained above, the dataset produced by the monitor survey provides enhanced results when a deblending process is applied to the dataset. In some embodiments, a dither may be applied to all of the nominal shot points of added sources S3 and S4 during the performance of the monitor survey to further enhance deblending results. In still further embodiments, a dither may also be added to all of the nominal shot points of repeat source S2, thus further enhancing deblending results. In embodiments for which it is desired to repeat actual shot points for the starboard baseline source, a dither is not applied to the nominal shot points of repeat source S1 during the monitor survey. In other embodiments, a dither may be applied to S1 if desired.

In the example of FIG. 16, sources S3 and S4 are the repeat sources in the monitor survey, while sources S1 and S2 constitute additional sources relative to the number of sources used in the baseline survey. Thus, for the same reasons described above, stars are used in FIG. 16 to indicate nominal shot points for sources S1 and S2 in the monitor survey. Dark colored circles in the S3 shot line of FIG. 16 indicate both actual shot points from the starboard baseline source and nominal shot points for S3 in the monitor survey. Light colored circles in the S4 shot line of FIG. 16 indicate actual shot points of the port side source from the baseline survey, while dark colored circles indicate nominal shot points for S4 in the monitor survey.

As can be seen from the drawing, all nominal shot points of repeat source S4 in the monitor survey of FIG. 16 are translated forward in the inline direction relative to the corresponding shot points of the baseline survey, but each of them remains on the shot line of the port side baseline source. Thus, for the same reasons explained above, repeat source S4 preserves the CMP coverage of the port side baseline source, as well as the fold and sample density of that source, with the sole compromise that each nominal shot point of repeat source S4 is translated a small distance in the inline direction relative to a corresponding shot of the port baseline source.

Meanwhile, overall fold and sampling density for the monitor survey of FIG. 16 are enhanced relative to that of the baseline survey due to the addition of sources S1 and S2, which in this case are both disposed on the starboard side of the repeat sources. Moreover, for the reasons explained above, the dataset produced by the monitor survey provides enhanced results when a deblending process is applied to the dataset. In some embodiments, a dither may be applied to all of the nominal shot points of added sources S1 and S2 during the performance of the monitor survey to further enhance deblending results. In still further embodiments, a dither may also be added to all of the nominal shot points of repeat source S4, thus further enhancing deblending results. In embodiments for which it is desired to repeat actual shot points for the starboard baseline source, a dither is not applied to the nominal shot points of repeat source S3 during the monitor survey. In other embodiments, a dither may be applied to S3 if desired.

### Example Methods According to Embodiments

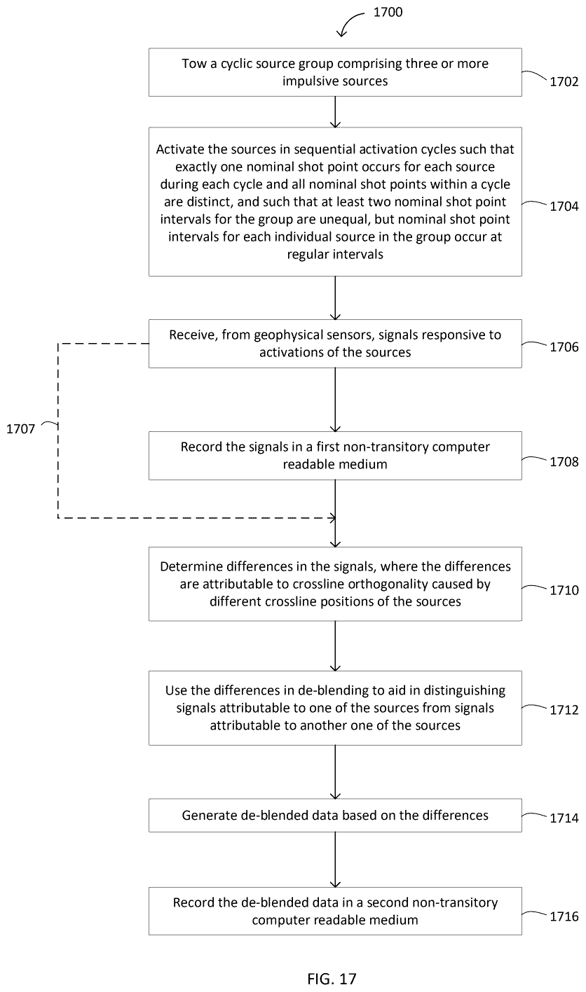

FIG. 17 illustrates a class of methods 1700 according to embodiments for using cyclic source groups that exhibit irregular nominal shot point intervals to manufacture various types of geophysical data products. In further embodiments, one or more non-transitory computer readable media may be produced having marine seismic survey instructions stored thereon that, when executed by one or more control systems onboard a vessel, cause the performance of steps in methods 1700.

At step 1702, a vessel is used to tow a cyclic source group consisting of a set of three or more impulsive marine seismic sources in a body of water during a marine seismic survey.

At step 1704, at least one controller is used to activate the sources in sequential activation cycles such that exactly one nominal shot point occurs for each of the sources in the set during each activation cycle, such that all nominal shot points within a given activation cycle are distinct, such that at least two nominal shot point intervals for the cyclic source group are unequal, and such that nominal shot point intervals occur at regular intervals for each individual source in the cyclic source group. Such a cyclic source group may comprise, for example, any of the cyclic source groups described above. In some embodiments, the at least one controller may be configured so that at least one of the sources in the cyclic source group repeats actual shot points or shot lines from a previous marine seismic survey, while one or more other sources in the cyclic source group are added relative to the number of sources used in the previous survey.

At step 1706, a set of geophysical sensors receives signals responsive to activations of the sources. The geophysical sensors may comprise any of the types described above, and they may be disposed in any suitable manner within the survey area, such as in seismic streamers, in seismic nodes, and/or in ocean bottom cables.

At step 1708, the signals or data derived from the signals may be recorded in a first non-transitory computer readable medium, thereby completing the manufacture of a first geophysical data product that comprises the first medium and the signals recorded thereon.

Steps 1710-1716 may be performed either after the survey is performed or contemporaneously with the survey. Thus, the signals used during step 1710 may be accessed from the computer readable medium produced in step 1708, or step 1710 may be performed using signals as they are produced during the survey, as indicated by dashed arrow 1707.

At step 1710, differences may be determined in the signals in the manner described above during a deblending process, where the differences are attributable to crossline orthogonality cause by different crossline positions of the sources within the cyclic source group.

At step 1712, the differences may be used in deblending among the sources in the cyclic source group to aid in distinguishing signals attributable to one of the sources from signals attributable to another one of the sources.

At step 1714, a set of de-blended signals is generated based on the differences.

Finally, at step 1716, the de-blended signals may be recorded in a second non-transitory computer readable medium, thereby completing the manufacture of a second geophysical data product that comprises the second medium and the de-blended signals recorded thereon.

### Example Source Group Locations

In surveys that employ a vessel to tow one or more seismic streamer spreads, one or more cyclic source groups such as those described above may in general be disposed at any crossline position and at any inline position relative to the streamer spread, including at positions on top of the streamer spread or beneath it, and including at positions that require a second vessel to tow the cyclic source group and/or that would require seismic nodes or cables in addition to the streamers to adequately register signals generated by the sources in the cyclic source group.

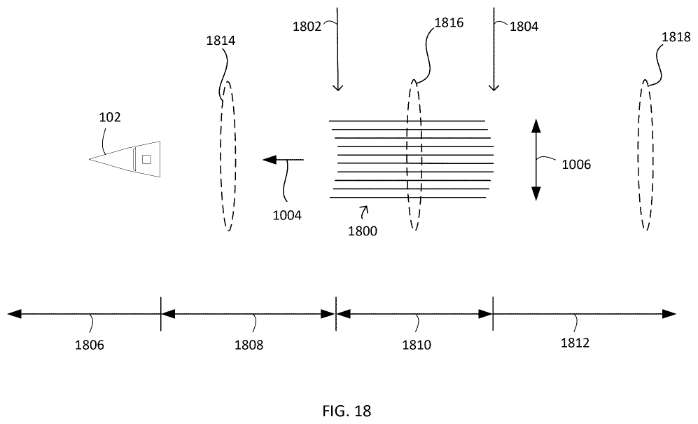

FIG. 18 illustrates several such possible locations by way of example. Referring now to FIG. 18, a vessel 102 is shown towing a streamer spread 1800, such as any of the streamer spreads described above, in an inline direction 1004. A crossline direction orthogonal to the inline direction is indicated at 1006. A forward end of one or more crossline centermost streamers defines a forward end 1802 of the streamer spread, while an aft end of the one or more crossline centermost streamers defines an aft end 1804 of the streamer spread. In various embodiments, any one or more cyclic source groups may be disposed at any crossline position in any or all of zones 1806, 1808, 1810, or 1812 during the survey. For embodiments in which it is desired to tow a cyclic source group with the same vessel that tows the streamer spread, then such a cyclic source group may be towed at inline positions anywhere in any of zones 1808, 1810, or 1812, at crossline positions that remain within a practical range of azimuths from the stern of the towing vessel, as indicate by way of example by dashed ovals 1814, 1816, and 1818.

Multiple specific embodiments have been described above and in the appended claims. Such embodiments have been provided by way of example and illustration. Persons having skill in the art and having reference to this disclosure will perceive various utilitarian combinations, modifications and generalizations of the features and characteristics of the embodiments so described. For example, steps in methods described herein may generally be performed in any order, and some steps may be omitted, while other steps may be added, except where the context clearly indicates otherwise. Similarly, components in structures described herein may be arranged in different positions or locations, and some components may be omitted, while other components may be added, except where the context clearly indicates otherwise. The scope of the disclosure is intended to include all such combinations, modifications, and generalizations as well as their equivalents.

What is claimed is:

1. A cyclic source group for marine seismic surveying, comprising:
a set of three or more impulsive marine seismic sources; and
at least one controller configured to activate the sources in sequential activation cycles, wherein the activation cycles are such that exactly one nominal shot point occurs for each of the sources in the set during each activation cycle and all nominal shot points within a given activation cycle are distinct;
wherein pairs of sequential nominal shot points within each activation cycle and across sequential activation cycles define respective nominal shot point intervals;
wherein at least two of the nominal shot point intervals are unequal; and
wherein nominal shot points for each individual source in the set occur at regular intervals.

2. The cyclic source group of claim 1, wherein:
the sources in the set are configured to be disposed at distinct crossline positions during a survey; and
a maximum one of the nominal shot point intervals corresponds to nominal shot points for sources in the set that are disposed at a minimum distance from one another in the crossline direction.

3. The cyclic source group of claim 2, wherein:
a minimum one of the nominal shot point intervals corresponds to nominal shot points for sources in the set that are disposed at a maximum distance from one another in the crossline direction.

4. The cyclic source group of claim 1, wherein:
the sources in the set are configured to be disposed at distinct crossline positions during a survey; and
a minimum one of the nominal shot point intervals corresponds to nominal shot points for sources in the set that are disposed at a maximum distance from one another in the crossline direction.

5. The cyclic source group of claim 1, wherein:
the at least one controller is configured to impose a dither on all nominal shot points for all sources in the set.

6. The cyclic source group of claim 5, wherein:
all of the imposed dithers are random dithers.

7. The cyclic source group of claim 1, wherein the at least one controller is configured such that:
at least a first one of the sources in the set repeats actual shot points from a previous marine seismic survey.

8. The cyclic source group of claim 7, wherein the at least one controller is configured such that:
a dither is applied to nominal shot points for at least a second one of the sources in the set, wherein the second source is distinct from the first source.

9. The cyclic source group of claim 1, wherein the at least one controller is configured such that:
at least two repeat sources in the set repeat respective shot lines from a previous marine seismic survey; and
a dither is applied to nominal shot points for at least a third source in the set, wherein the third source is distinct from the two repeat sources.

10. The cyclic source group of claim 9, wherein the at least one controller is configured such that:
nominal shot points for one of the repeat sources is translated in an inline direction relative to actual shot points for a corresponding source in the previous marine seismic survey.

11. The cyclic source group of claim 10, wherein the at least one controller is configured such that:
a dither is applied to nominal shot points for the translated one of the repeat sources.

12. The cyclic source group of claim 11, wherein the at least one controller is configured such that:
a dither is not applied to nominal shot points for an untranslated one of the repeat sources.

13. The cyclic source group of claim 1, wherein the at least one controller is configured such that:
at least two crossline adjacent repeat sources in the set repeat shot lines form a previous marine seismic survey; and
at least one crossline outermost source in the set comprises an additional source relative to a number of sources that were used in the previous marine seismic survey.

14. The cyclic source group of claim 13, wherein
the at least one controller is configured such that at least two repeat sources in the set repeat respective shot lines from a previous marine seismic survey;
at least two other sources in the set are configured to be disposed such that both are on a starboard side or both are on a port side of the two repeat sources; and
wherein the at least two other sources comprise additional source relatives to a number of sources that were used in the previous marine seismic survey.

15. The cyclic source group of claim 14, wherein the at least one controller is configured such that:
nominal shot points for one of the repeat sources is translated in an inline direction relative to actual shot points for a corresponding source in the previous marine seismic survey;
a dither is applied to nominal shot points for the translated one of the repeat sources; and
dithers are applied to nominal shot points for the at least two other sources.

16. The cyclic source group of claim 15, wherein the at least one controller is configured such that:
a dither is not applied to nominal shot points for an untranslated one of the repeat sources.

17. The cyclic source group of claim 1, wherein:
all of the sources in the set are configured to be disposed at a same inline position.

18. The cyclic source group of claim 1, wherein:
the set of sources consists of three sources, S1, S2, and S3, configured to be disposed equidistant from one another at distinct crossline positions during a survey such that S2 is between S1 and S3 in the crossline direction;
nominal shot points occur for the sources in a sequence S2, S1, S3 during each activation cycle;
a nominal shot point interval between S2 and S1 corresponds to a maximum nominal shot point interval; and
a nominal shot point interval between S1 and S3 corresponds to a minimum nominal shot point interval.

19. The cyclic source group of claim 18, wherein:
a nominal shot point interval between S3 and S2 across sequential activation cycles corresponds to the maximum nominal shot point interval.

20. The cyclic source group of claim 18, wherein:
a nominal shot point interval between S3 and S2 corresponds to an intermediate nominal shot point interval smaller than the maximum nominal shot point interval and larger than the minimum nominal shot point interval.

21. The cyclic source group of claim 1, wherein:
the set of sources consists of four sources, S1, S2, S3, and S4, configured to be disposed equidistant from one another at distinct crossline positions during a survey such that S1 and S4 are outermost in the crossline direction, S2 is adjacent to S1 in the crossline direction, and S3 is adjacent to S4 in the crossline direction;
nominal shot points occur for the sources in a sequence S1, S3, S2, S4 during each activation cycle;
a nominal shot point interval between S3 and S2 corresponds to a maximum nominal shot point interval; and
a nominal shot point interval between S4 and S1 corresponds to a minimum nominal shot point interval.

22. A method of manufacturing a geophysical data product, comprising:
towing, from a vessel, a set of three or more impulsive marine seismic sources in a body of water during a marine seismic survey;
activating the sources in sequential activation cycles, wherein the activation cycles are such that exactly one nominal shot point occurs for each of the sources in the set during each activation cycle and all nominal shot points within a given activation cycle are distinct;
wherein pairs of sequential nominal shot points within each activation cycle and across sequential activation cycles define respective nominal shot point intervals;
wherein at least two of the nominal shot point intervals are unequal; and
wherein nominal shot points for each individual source in the set occur at regular intervals;
receiving, from geophysical sensors, signals responsive to activations of the sources; and
recording the signals or data derived therefrom in a first set of one or more non-transitory computer readable media, thereby completing the manufacture of a first geophysical data product.

23. The method of claim 22, wherein:
the sources in the set are disposed at distinct crossline positions; and
a maximum one of the nominal shot point intervals corresponds to nominal shot points for sources in the set that are disposed at a minimum distance from one another in the crossline direction.

24. The method of claim 23, wherein:
a minimum one of the nominal shot point intervals corresponds to nominal shot points for sources in the set that are disposed at a maximum distance from one another in the crossline direction.

25. The method of claim 22, wherein:
the sources in the set are disposed at distinct crossline positions; and
a minimum one of the nominal shot point intervals corresponds to nominal shot points for sources in the set that are disposed at a maximum distance from one another in the crossline direction.

26. The method of claim 25, further comprising:
determining differences in the signals attributable to crossline orthogonality caused by different crossline positions of the sources in the set;
generating a de-blended set of signals based on the differences; and
recording the de-blended set of signals or data derived therefrom in a second set of one or more non-transitory computer readable media, thereby completing the manufacture of a second geophysical data product.

27. At least one non-transitory computer readable medium having marine seismic survey instructions stored thereon that, when executed by one or more control systems onboard one or more vessels, cause the performance of actions comprising:
towing, from a vessel, a set of three or more impulsive marine seismic sources in a body of water during a marine seismic survey; and
activating the sources in sequential activation cycles, wherein the activation cycles are such that exactly one nominal shot point occurs for each of the sources in the set during each activation cycle and all nominal shot points within a given activation cycle are distinct;
wherein pairs of sequential nominal shot points within each activation cycle and across sequential activation cycles define respective nominal shot point intervals;
wherein at least two of the nominal shot point intervals are unequal; and
wherein nominal shot points for each individual source in the set occur at regular intervals.

28. The medium of claim 27, wherein:
the sources in the set are disposed at distinct crossline positions; and
a maximum one of the nominal shot point intervals corresponds to nominal shot points for sources in the set that are disposed at a minimum distance from one another in the crossline direction.

29. The medium of claim 28, wherein:
a minimum one of the nominal shot point intervals corresponds to nominal shot points for sources in the set that are disposed at a maximum distance from one another in the crossline direction.

30. The medium of claim 27, wherein:
at least two repeat sources in the set repeat respective shot lines from a previous marine seismic survey; and
at least a third source in the set, distinct from the at least two repeat sources, comprises an additional source relative to a number of sources used during the previous marine seismic survey.
